(19) United States
(12) Patent Application Publication
(10) Pub. No.: US 2006/0138111 A1
(43) Pub. Date: Jun. 29, 2006

(54) Method for determining the focal position of a laser beam

(75) Inventors: Dirk Hillebrand, Bruchsal (DE); Hans Juergen Mayer, Viernheim (DE); Christian Overmann, Hamburg (DE)

Correspondence Address: SIEMENS SCHWEIZ;I-44, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 10/536,037

(22) PCT Filed: May 30, 2003
(86) PCT No.: PCT/DE03/01780

§ 371 Date: Oct. 19, 2005

(30) Foreign Application Priority Data
Nov. 28, 2002 (DE) 10255628.8

(51) Int. Cl. B23K 26/03

(52) U.S. Cl. 219/121.83

(57) ABSTRACT

Disclosed is a method for determining the focal position of a laser beam, according to which a plurality of linear patterns are first created on the surface of a sample substrate by the laser beam, the distance between the laser and the substrate surface being gradually modified. The width of the individual lines is then measured and the line having the smallest width is determined. The vertical setting associated with the smallest line width is evaluated and stored as the focal setting of the machine.

The invention relates to a method for determining the focal position of a laser beam in a machine for processing substrates, in particular electrical circuit substrates.

Accurate knowledge of the focal position of the laser beam in relation to the machining planes is important and necessary for the processing of substrates of printed circuit boards or other circuit substrates for instance. The determination of the focal position is therefore an important step in the commissioning of a laser machining device, however an examination of this focal position and/or a renewed determination is also repeatedly required during operation. The focal position determination must thus be able to be carried out in a simple, objective and reproducible manner.

The usual method has previously been to undertake and evaluate the focal determination manually with the aid of a microscope. This process is therefore dependent on the person carrying out said process, and on the quality of the measuring instrument used, namely the microscope. This method is therefore not only time-consuming but is also subject to an alternating source of errors, since it depends on a particular person.

The aim of the present invention is to specify a method for determining the focal position in a laser machining device, which is independent of personnel and therefore objective, and which enables the quick and highly accurate determination of the focal position.

In accordance with the invention, the focal position is therefore determined using the following steps:

a plurality of linear patterns are created on the surface of a sample substrate by means of the laser beam, the distance between the laser and the substrate surface being gradually modified,

the line width of all patterns is measured and assigned to the relevant distance value, and

the pattern with the smallest line width is determined, and the associated distance value is identified as a focal setting of the laser beam.

In the invention, the lines arranged in parallel are therefore structured at different predefined distance heights. In this method the narrowest line width is identical to the focal position, which can then be accepted as a parameter during the evaluation. Since the pattern of lines which can be created in the form of straight lines or of circles arranged in parallel for instance, differ from one another as a result of the gradually changing distances, a direct visual evaluation is possible, so that a manual determination is also possible in many cases without a microscope. Nevertheless an objective comparison of the line widths is possible.

In a preferred embodiment, the line width of the individual pattern is measured and determined with the aid of a camera. This allows the focal position to be accurately determined to 100 μm independent of any personnel and enables a fully automated system to be set up during the complete implementation of the method, which automatically carries out the focal search at high speeds, the defect influence factors being minimized by an individual assessment. A camera is preferably used here which is already present in the machine for detecting markings and positions. The camera can operate using similar algorithms and test programs as are also used for the fiducial detection and/or the calibration. An additional external camera can also be used for this purpose. It is also possible to operate the camera with a zoom lens, if the structured line width is too small for certain applications or laser wavelengths.

As mentioned, the linear patterns are implemented at different vertical positions in the method according to the invention, i.e. in an x-y-z coordinate system with different z-values. The determination of the difference of the different z-heights allows a rough or fine search. With the rough search, the vertical difference between the individual structuring steps is larger than in the case of a fine search. Furthermore, the selection of the search steps can effect reactions to different sharpnesses of the different wavelengths (with the same focal length). The sharpness is far greater with a CO₂ laser (with a wavelength of 9.25 μm) than with a UV laser with a wavelength of 355 nm. This means that the change in the structured line width is far less with a CO₂ laser than with a UV laser, as a function of the change in the z-height.

Exemplary embodiments of the invention are described in more detail below with reference to the drawing, in which;

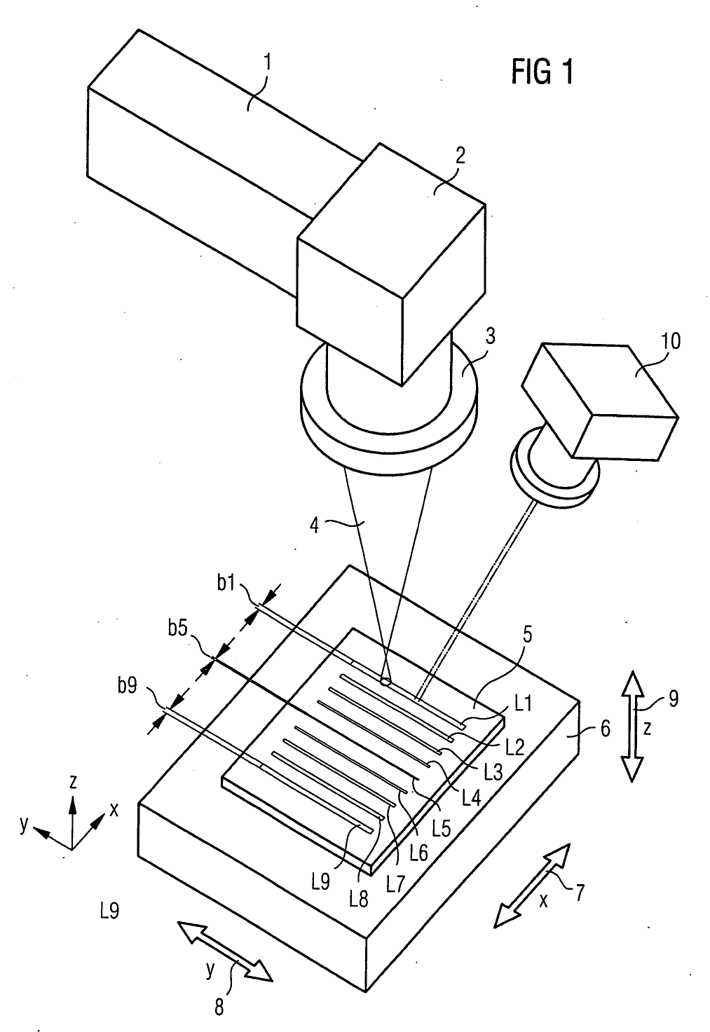

FIG. 1 shows a schematic representation of a laser processing arrangement with a focal determination according to the invention,

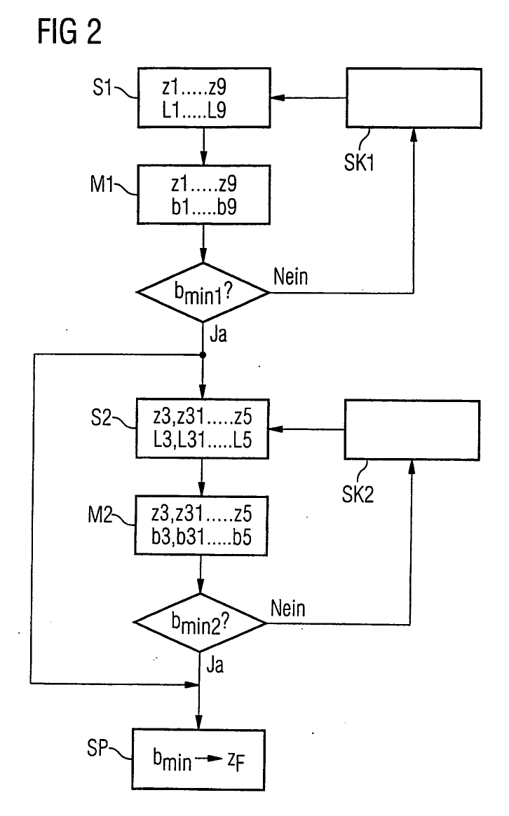

FIG. 2 shows a flowchart for an automatic focal search according to the invention,

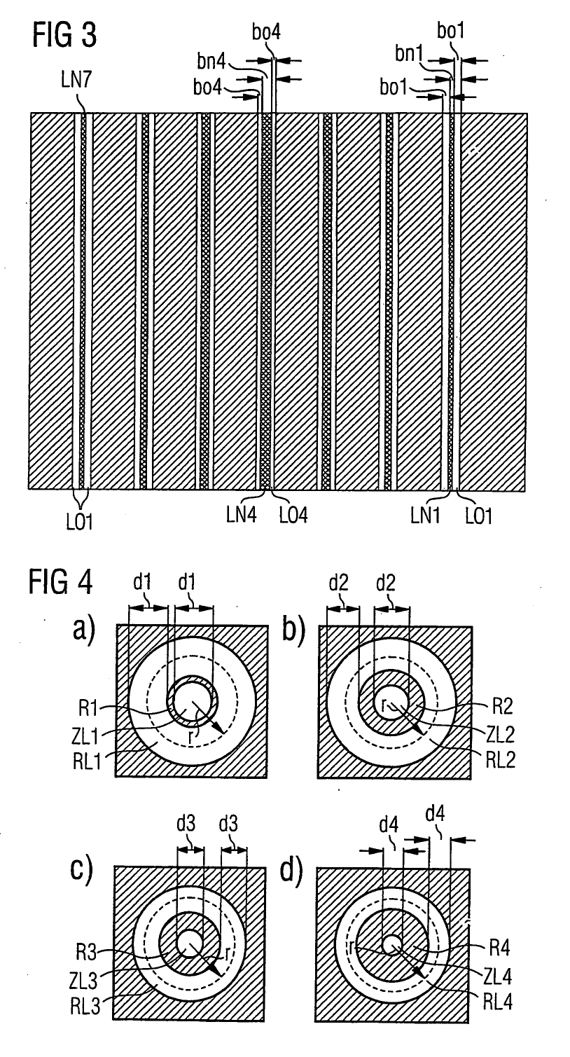

FIG. 3 shows the schematic representation of a pattern with straight lines created for the focal determination and

FIG. 4 shows the schematic representation of a pattern in the form of circular lines created for the focal determination.

FIG. 1 shows the basic arrangement of a laser machine for the processing of printed circuit boards or similar substrates. In this Figure, a schematically represented laser 1 generates a laser beam 4 via a deflection unit, for example with galvo mirrors (not shown), and an imaging unit and/or lens 3. A focus F is set by means of the focal length of the lens 3. The substrate 5 to be processed is arranged on a table 6, which can be set in an x-y-z coordinate system via a corresponding x-drive 7, y-drive 8 and a z-drive 9. The drives 7, 8 and 9 are indicated schematically by means of a double arrow. Provided it is a planar substrate, the x-drive 7 and the y-drive 8 set the substrate in a determined processing level, so that the respectively provided processing point is detected by the laser beam 4. The height of the table 6 and/or the substrate 5 is set by means of the z-drive 9, whereby the distance to the laser is modified. Depending on the requirement, the substrate is thus deliberately brought into the focal position relative to the laser beam or deliberately out of focus. The further the surface of the substrate 5 lies outside the focus, the larger the spot diameter of the impinging laser beam, and the lower the effective energy density. An accurate determination of the focal position of the laser in terms of the z-vertical of the table 6 is needed for the targeted processing of the substrate 5.

In accordance with the invention, a sample substrate 5 is placed on the table 6 for the determination of the focal position, and sample lines are created using the laser beam, straight lines L1 to L9 in the example shown in FIG. 1. The table 6 is gradually modified in this process so that another z-height (z1 to z9) is to be assigned to each line L1 to L9.

A camera 10, already included in the machine for example, said camera being used for the fiducial and position detection, enables the individual sample lines to be focused on, and the respective line widths 6 can be determined on the substrate. A specific z-vertical position of the table is assigned to each line width b (b1 to b9). The focal position is determined by determining the minimum line width bₘᵢₙ and the associated z-height position of the table 6 is characterized as the focal position.

An assignment results according to the table below:

| | Line | | | | | | | | |
|---|---|---|---|---|---|---|---|---|---|
| | L1 | L2 | L3 | L4 | L5 | L6 | L7 | L8 | L9 |
| z-position | Z1 | Z2 | Z3 | Z4 | Z5 | Z6 | Z7 | Z8 | Z9 |
| Line widths | B1 | B2 | B3 | B4 | B5 | B6 | B7 | B8 | B9 |

In the example in FIG. 1, the line L5 has the smallest width b5 (=bₘᵢₙ). Correspondingly, the associated vertical z5 is identified as a focal position and stored in the system.

In practice the different heights are achieved by the structuring in different vertical positions with predetermined z-values. In such cases the determination of the difference of the different z-vertical allows a rough and fine search. A method of this type is shown for exemplary purposes in the flowchart in FIG. 2. A rough positioning is carried out initially in a first search step S1. This involves moving to vertical positions with the values z1 to z9, each creating a line L1 to L9 respectively. In the next step M1, the line widths b1 to b9 are measured and assigned to the height values z1 to z9. If a minimum value can be recognized from the series of measured line widths, a minimum line width is determined from the measurement values b1 to b9. If, however, no minimum is passed during the measurement of the line widths, which is case if the smallest measured line width lies at the end of the measurement row, the rough search in step S1 must be carried out with new z-values. Step SK1 therefore provides further z-values following on from the current z-value with the smallest line width (e.g. z9 to z15). A new series of measurements can then be undertaken with steps S1 and M1.

If a first minimal width value b_{min 1} is determined in the rough search, the focal distance can be more accurately determined in a fine search. In a second search step S2, further z-values are determined in the region both sides of the previously determined minimum value b_{min 1} and/or the associated z-value, for example fine z-position values z31, z32 etc between the vertical values z3 and z5. In turn, associated sample lines L3, L31, L32 . . . to L49, L5 are measured according to these fine vertical differences. A minimum value b_{min 2} is then determined from the measured line widths, and the associated z-height value z_{F} is determined as a focal position of the table and/or the substrate and stored in a step SP.

The following table applies to the fine search for example:

| | |
|---|---|
| Line | L3 L31 L32 . . . L42 . . . L49 L5 |
| z-position | Z3 z31 z32 . . . z42 . . . z49 z5 |
| Line width | B3 b31 b32 . . . b42 . . . b49 b5 |

If the width comparison results in a minimum for b42, the associated vertical value z42 corresponds to the focal position and is stored as Z_{F}.

Naturally the second search step can also be dispensed with depending on the conditions, then the value b_{min 1} can be directly stored in step SP, as shown in FIG. 2.

The camera can thereby operate with algorithms and test programs similar to those used for the fiducial detection and/or calibrations of the machine. Instead of the camera provided here, a second external camera could also be provided. It is also possible to operate the camera with a zoom lens, if the structured line widths are too small for particular applications or laser wavelengths.

In order to be able to distinguish the individual sample lines even with small vertical steps, the sample substrate can be provided with a specific surface. A pattern is shown in FIG. 3 for example which is created on an anodized aluminum disk by means of CO₂ laser beams. The thermal conversion of the eloxal causes the line structure to develop. The performance and the dimension of the line structure are dependent on the focal size and the energy density linked thereto. A vaporization of the eloxal and nitration of the aluminum which is shown using a gold colored line, takes place in the central region of the laser beam, due to the high energy density. The eloxal converts into aluminum oxide in the border area as a result of heat exposure, this being recognizable from its the white coloring. Both colored regions can be clearly recognized in contrast to the black or dark anodized aluminum.

An evaluation is thereby possible in that the focal dimensions and the energy density linked thereto vary with defocusing, this being shown in different line widths of the aluminum nitride on the one hand and of the aluminum oxide on the other hand depending on the focal height. An improved focusing thus causes the width of the nitrified track to increase and the width of the aluminum oxide track to reduce. FIG. 3 shows a width bn1 of the nitride layer LN1 in the border area, said width being smaller than a width bn4 of the nitride layer LN4 in the middle of the substrate, which correspondingly demonstrates an improved focus. Conversely, the width bo1 of the aluminum oxide layer LO1 is larger on the border than the corresponding width bo4 of the aluminum layer LO4 in the central region and/or with improved focusing. Since this type of line generation produces different lines in each instance, which behave in opposite ways during focusing, two different evaluation methods or even a combination of the two measurement methods is conceivable. The focal determination based on the oxide track width is more suitable with a black and white camera evaluation, since the light-colored nitrated region cannot easily be further separated from the light-colored oxide region. To avoid hard shadows, the illumination should be selected such that it falls on the target as much as possible from above. A camera with image detection detects the correlating line width for a specific number of focal heights and outputs the value or stores it for an internal further processing. The focal position determination results from the determination of the minimum of the polynomial fit of the second order of all determined values. A polynomial fit is carried out in order to suppress measurement defects. The minimum determined in this way correlates with the focal position of the system.

In a further exemplary embodiment in FIG. 4, a pattern for focal position determination is shown made up of circular patterns. In this way a circle sample is structured such that a laser impulse is initially placed on the circular center point, whereby a hole ZL is created with the spot diameter d, and a circle with a predetermined radius r is structured around said center point. The diameter d of the central hole ZL and the width of the external ring RL, which appear white in the image, are smaller or larger depending on the focusing, both correspond in each instance to the spot diameter corresponding to the focusing of the laser beam. A dark ring R remains between the central hole ZL and the outer ring R, the width of which is simultaneously influenced by the size change of both the central hole ZL and the external ring hole RL, so that this size change is particularly clear and can be easily measured.

FIG. 4a shows the case for a laser beam set at the most extreme out of focus. In this case, the spot diameter d1 is particularly large, and the remaining ring R1 is particularly small. In the subsequent FIGS. 4b, 4c and 4d, the spot diameters d2, d3 and d4 become continuously smaller. Correspondingly, holes ZL2, RL2, ZL3, RL3 and ZL4, RL4 become increasingly smaller, whilst the dark ring R2, R3, and finally R4 remaining between them becomes increasingly wider. FIG. 4d shows the optimum focusing of the laser beam. A further modification in the distance between the laser and the sample substrate would result in a defocusing, thus an increase in the spot diameter. A pattern corresponding to 4c would thus again follow on from 4d.

In addition to patterns with straight lines and circular rings shown for exemplary reasons, any other patterns for the focal detection according to the invention can also be created.

1. A method for determining a focal position of a laser beam in a machine for processing substrates comprising the steps of:
generating a plurality of linear patterns on a planar surface of a sample substrate by means of the laser beam, such that a distance between an imaging unit of the laser beam and of the planar substrate surface is gradually modified,
storing associated distance value for each pattern created,
measuring line width of all patterns and assigning measured line width values to respective distance values, and
determining a pattern with the smallest line width, and identifying an associated distance value as a focal setting of the laser beam.

2. The method according to claim 1, further comprising the steps of:
changing a distance between the imaging unit of the laser beam and the sample substrate in large steps in a first measurement pass in order to determine a rough focal region, and
modifying the distance between the imaging unit of the laser beam and the sample substrate in a second measurement pass in small steps within a determined focal region, in order to identify an accurate focal setting.

3. The method according to claim 1, wherein
a size of the search steps is chosen as a function of a wavelength of the laser beam such that larger wavelengths effect larger search steps.

4. The method according to claim 1, further comprising the steps of:
using an anodized aluminum plate as a sample substrate with an eloxal layer in a central region of the laser beam being vaporized by the line structure created by the laser beam and aluminum lying below it being nitrated, whilst the eloxal is converted into aluminum oxide in the border area and the width of the nitrated track increases with an increasing focusing and the width of the oxide track reduces such that optionally the width development of the nitride track and/or the oxide track is included in the evaluation.

5. The method according to claim 1, wherein patterns are generated in a form of a circular line structure.

6. The method according to claim 1, wherein line width and/or structure width of the pattern is measured with aid of a camera, and measurement data is evaluated by means of a known image processing algorithm.

7. The method according to claim 1, wherein the substrates are electrical substrates.
